(19) United States
(12) Patent Application Publication
(10) Pub. No.: US 2021/0114055 A1
(43) Pub. Date: Apr. 22, 2021

(54) FLUID METERING SYSTEM UTILIZING A ROTATABLE SHAFT

(71) Applicant: NORDSON CORPORATION, WESTLAKE, OH (US)

(72) Inventors: Mario ROMANIN, Valley City, OH (US); Rafael LEON, Elyria, OH (US); Mike BORDNER, Toledo, OH (US); Carl BARON, Avon, OH (US)

(21) Appl. No.: 17/253,267

(22) PCT Filed: Jun. 27, 2019
(86) PCT No.: PCT/US2019/039388

§ 371 Date: Dec. 17, 2020

Related U.S. Application Data
(60) Provisional application No. 62/690,806, filed on Jun. 27, 2018.

(51) Int. Cl. B05C 5/02; G01F 13/00

(52) U.S. Cl. CPC B05C 5/0233; G01F 13/006

(57) ABSTRACT

A dispensing apparatus for dispensing a fluid includes a dispenser body having a fluid chamber that receives the fluid, an outlet disposed on the dispenser body and that fluidly communicates with the fluid chamber, and a shaft disposed within the fluid chamber. The shaft at least partially defines a variable passage for the fluid to move therethrough from the fluid chamber to the outlet. The dispensing apparatus transitions between a plurality of dispensing configurations, and the variable passage is defined to have a different dimension for each of the plurality of dispensing configurations.

### CROSS REFERENCE TO RELATED APPLICATIONS

This application is a National Stage Application of International Patent App. No. PCT/US2019/039388, filed Jun. 27, 2019, which claims the benefit of U.S. Provisional Patent App. No. 62/690,806, filed Jun. 27, 2018, the entire disclosures of both of which are hereby incorporated by reference as if set forth in their entireties herein.

### TECHNICAL FIELD

The present disclosure relates generally to fluid metering systems, and more particularly to a fluid metering system utilizing a rotatable shaft.

### BACKGROUND

Fluid material may be dispensed as discreet shots, dots, or beads of a precise volume of adhesive. Controlled volume dispensing or metering is particularly useful when the dispensed fluid is expensive, or when it is necessary to precisely mix two or more different fluids, such as multi-component adhesives.

There are shortcomings with the conventional fluid dispensing systems. Prior fluid metering systems have utilized reciprocating pistons to meter the volume of fluid dispensed. These systems typically utilize air or hydraulic pressure to actuate the piston between fill and dispense directions. Moreover, conventional piston metering systems typically dispense a single shot of fluid per cycle of piston reciprocation, thereby limiting the speed at which the fluid can be dispensed to the reciprocating speed of the piston. Additionally, the size and shape of the dispensed material is substantially constant, and it is difficult to vary these parameters quickly and effectively.

Therefore, there is a need for an improved metering systems that provides increased dispensing rates, simplified operation, and easier variation of the size and shape of the dispensed material.

### SUMMARY

The foregoing needs are met by the various aspects of dispensing apparatuses and methods of dispensing disclosed in this application. According to an aspect of this disclosure, a dispensing apparatus for dispensing a fluid includes a dispenser body having a fluid chamber configured to receive the fluid, an outlet disposed on the dispenser body and configured to fluidly communicate with the fluid chamber, and a shaft disposed within the fluid chamber. The shaft at least partially defines a variable passage for the fluid to move therethrough from the fluid chamber to the outlet. The dispensing apparatus is configured to transition between a plurality of dispensing configurations, and the variable passage has a different dimension for each of the plurality of dispensing configurations.

According to another aspect, a system for dispensing a fluid onto a substrate includes a dispensing apparatus having a dispenser body defining a fluid chamber configured to receive the fluid, an inlet in fluid communication with the fluid chamber and configured to receive the fluid from a fluid source, an outlet in fluid communication with the fluid chamber and for the fluid to pass therethrough out of the fluid chamber, a metering member disposed within the fluid chamber, a nozzle disposed on the dispensing apparatus and configured to direct the fluid from the outlet to the substrate, and an actuator configured to transition the dispensing apparatus between a plurality of dispensing configurations. The metering member defines a variable passage for the fluid to move therethrough from the fluid chamber to the outlet. The variable passage has a different dimension at each of the plurality of dispensing configurations.

According to another aspect, a method of dispensing a fluid onto a substrate uses a dispensing apparatus having a dispenser body defining a fluid chamber is disclosed. Initially, the dispensing apparatus is operated in a first configuration to dispense a first quantity of the fluid from an outlet of the dispensing apparatus. A shaft disposed within the fluid chamber is then rotated. The shaft at least partially defines a variable passage for the fluid to move therethrough from the fluid chamber to the outlet. The dispensing apparatus is then operated in a second configuration to dispense a second quantity of the fluid from the outlet of the dispensing apparatus, the first quantity being different from the second quantity.

### BRIEF DESCRIPTION OF THE DRAWINGS

The present application is further understood when read in conjunction with the appended drawings. For the purpose of illustrating the subject matter, there are shown in the drawings exemplary embodiments of the subject matter; however, the presently disclosed subject matter is not limited to the specific methods, devices, and systems disclosed. In the drawings:

FIG. 1 illustrates an isometric view of a dispensing system according to an aspect of the disclosure;

FIG. 2 illustrates a cross-sectional view of the dispensing system of FIG. 1;

FIG. 3 illustrates an isometric cross-sectional view of a dispenser according to an aspect;

FIG. 4 illustrates another isometric cross-sectional view of the dispenser of FIG. 3;

FIG. 5 illustrates a cross-sectional view of a dispenser according to an aspect;

FIG. 6 illustrates a metering member with a bushing according to an aspect;

FIG. 7 illustrates an isometric cross-sectional view of the metering member with the bushing of FIG. 6;

FIG. 8 illustrates a metering member according to an aspect;

FIG. 9A illustrates an isometric view of a portion of a metering member according to another aspect;

FIG. 9B illustrates an isometric view of a portion of a metering member according to another aspect;

FIG. 10A illustrates a configuration of the dispenser according to an aspect;

FIG. 10B illustrates another configuration of the dispenser according to another aspect;

FIG. 10C illustrates another configuration of the dispenser according to another aspect;

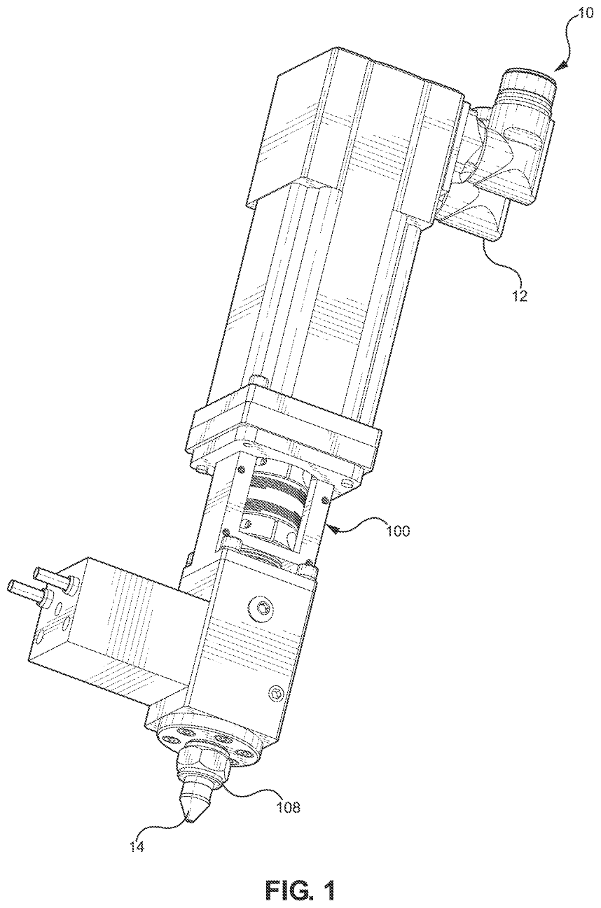

FIG. 1 OD illustrates another configuration of the dispenser according to another aspect;

FIG. 11A illustrates a front view of a bushing according to an aspect;

FIG. 11B illustrates an isometric view of the bushing of FIG. 11A; and

FIG. 11C illustrates another isometric view of the bushing of FIGS. 11A and 11B.

Aspects of the disclosure will now be described in detail with reference to the drawings, wherein like reference numbers refer to like elements throughout, unless specified otherwise.

### DETAILED DESCRIPTION

The present disclosure provides a fluid metering system for dispensing discrete, controlled volumes of fluid, such as adhesive, with increased cycle rates and better precision as compared to existing technology. The methods and apparatus disclosed herein provide the option to dispense precise and repeatable quantities or volume of material over a wide range of viscosities and substrates.

With reference to FIG. 1, an exemplary aspect of a dispensing system 10 is illustrated. The dispensing system 10 receives a material into a dispenser 100 from a material source (not shown) and dispenses the material onto a suitable substrate (not shown). The dispensing system 10 may include multiple dispensers 100 operating together or in a predetermined order. A controller 12, such as a processor, may be operatively connected to the dispensing system 10 to send and/or receive signals to and/or from the one or more dispensers 100. The controller 12 may be preconfigured to instruct each dispenser 100 to operate in accordance to one or more programs or procedures, be controllable directly by a user, and be able to automatically alter operation of the one or more dispensers 100 based on preset configurations or data received from one or more sensors associated with various parameters of fluid dispensing.

The dispensing system 10 is configured to dispense a fluid or viscous material and is configurable to dispense a predetermined quantity of material at predetermined intervals. In some aspects, the dispensing system 10 functions as a metering device that receives a fluid material and dispenses it according to specific measurements and parameters. In other aspects, the dispensing system 10 may further alter the material before dispensing it, for example, heating, melting, or mixing the material, and the dispensing system 10 may include additional structural elements (not shown) for these purposes, such as heaters, mixers, or sensors. Although the aspects described throughout this application receive and dispense fluid material, it will be understood that the material entering the dispensing system 10 may be in solid form and then melted to a liquid form. Multiple materials having different physical parameters may be introduced into the dispensing system 10 for modification and dispensing.

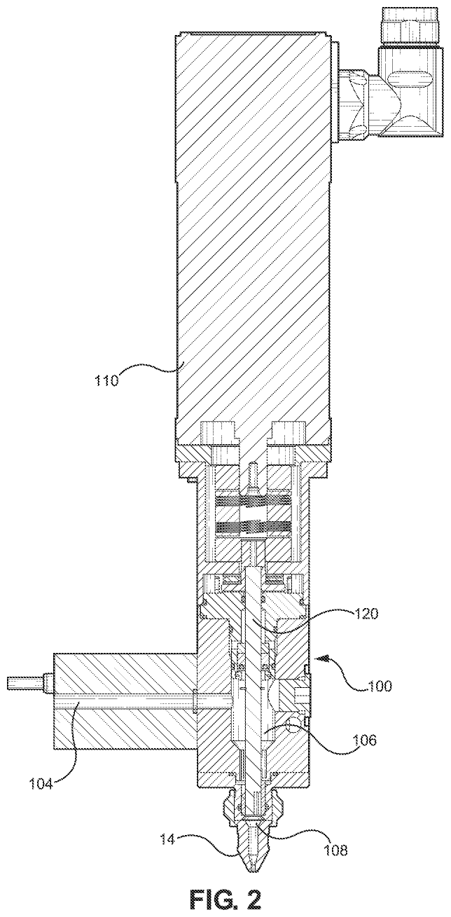

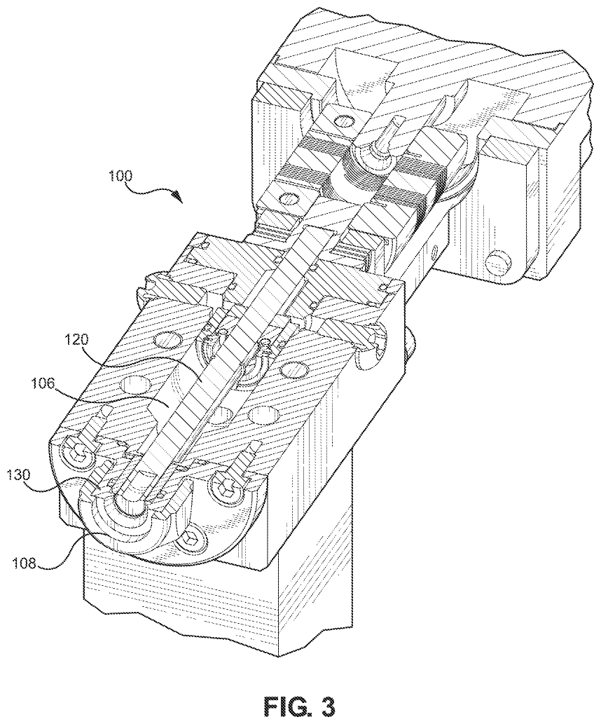

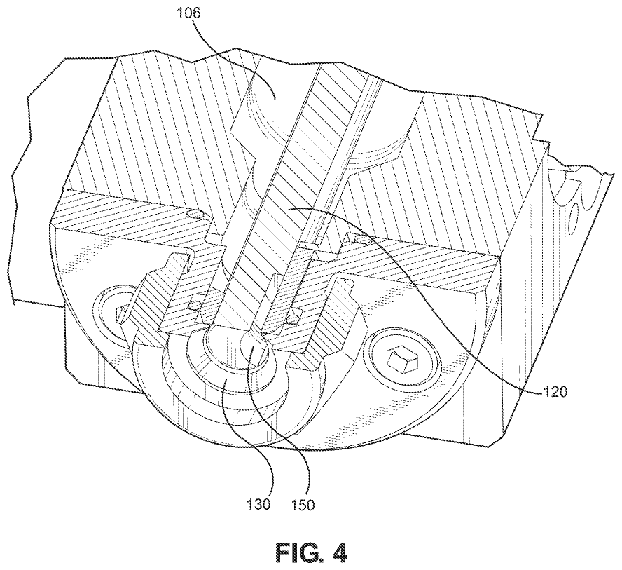

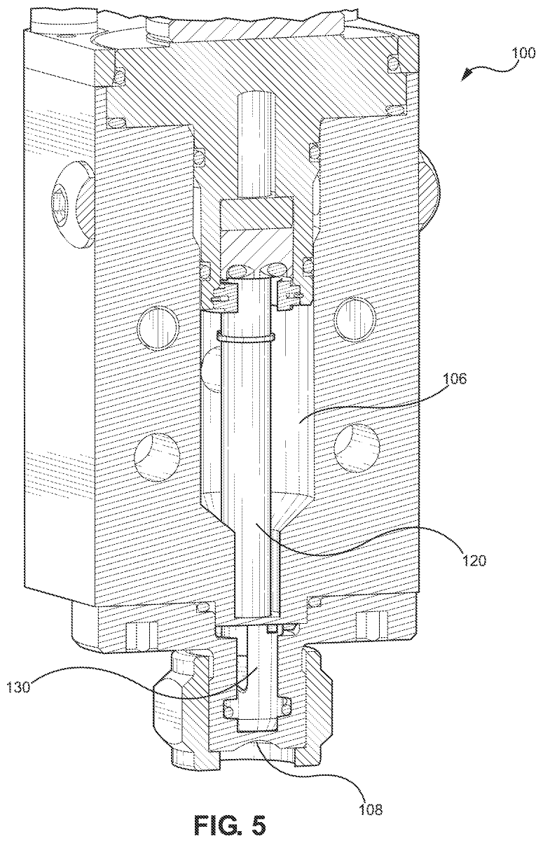

FIGS. 2-5 depict aspects of a dispenser 100. The dispenser 100 includes an inlet 104 for the fluid material, a fluid chamber 106, and an outlet 108 through which the fluid material is dispensed onto a substrate (not shown). The inlet 104 and the outlet 108 fluidly communicate with the fluid chamber 106 and are configured to permit the fluid material to travel therethrough into and out of the fluid chamber 106, respectively. A nozzle 14 may be disposed adjacent to the outlet 108 and be configured to direct the dispensed fluid material onto the substrate.

The dispenser 100 further includes an actuator 110 configured to control the dispensing action of the fluid material out of the dispenser 100. The actuator 110 may include a motor and suitable electronic connections to receive signals with specific operational instructions from, for example, the controller 12. In some aspects, the actuator 110 may be a servo motor configured to rotate in a first rotational direction and in a second rotational direction opposite the first direction. It will be understood that other types of motors may be used, for example, a stepper motor or a direct current (DC) motor.

The servo motor may rotate in the first and/or second directions in response to one or more commands issued from the controller 12 or from another control device, such as a remote input device (not shown). The speed of rotation of the servo motor may be controlled and modified based on the necessary specifications and desired use of the dispenser 100.

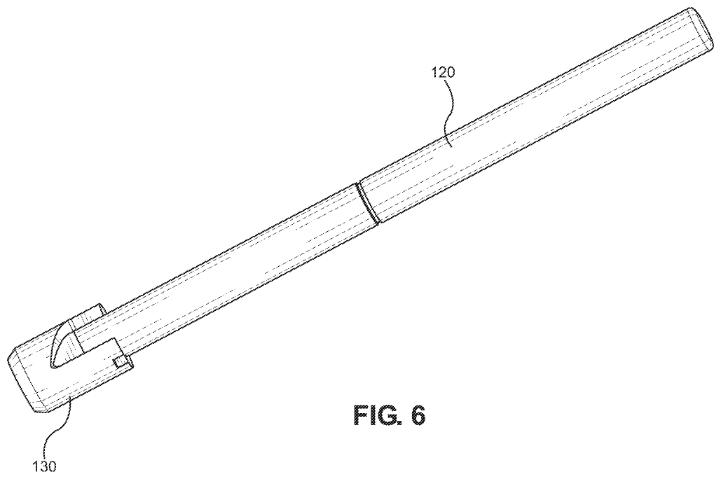

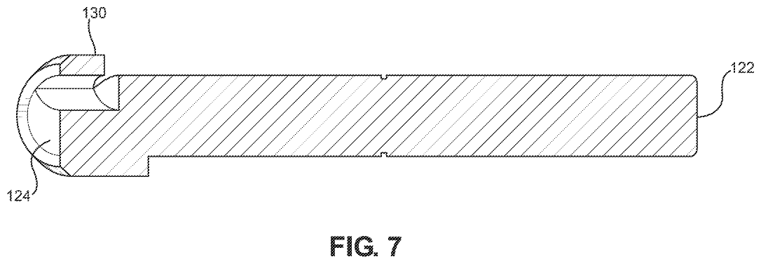

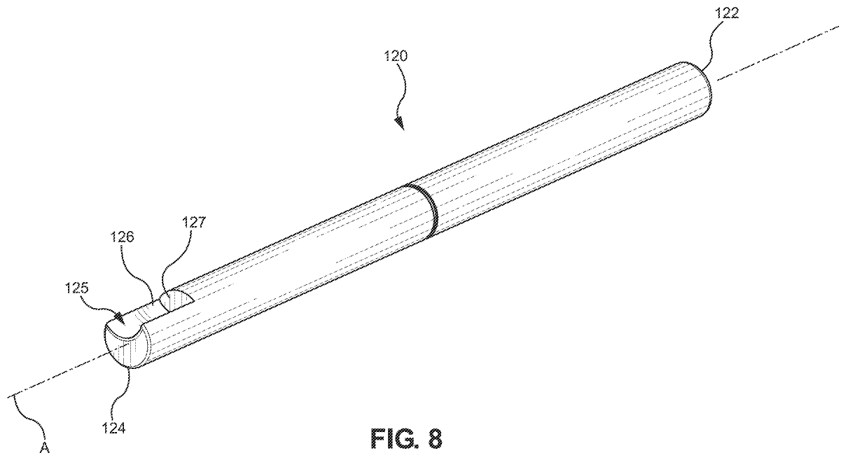

The actuator 110 may operatively communicate with and/or engage with a metering member 120. The metering member 120 may be moved and/or rotated by the actuator 110, and the movements may correspond to desired dispensing characteristics, such as the quantity dispensed, size and shape of the dispensed material, duration of dispensing, dispensing patterns, or other characteristics typically used in fluid dispensing. As depicted in FIGS. 6-9B, the metering member 120 may be a shaft. The actuator 110 may move the shaft 120 axially within the fluid chamber 106, such that the shaft 120 moves in a first direction toward the outlet 108 or in a second direction away from the outlet 108. Alternatively, the actuator 110 may rotate the shaft 120 in the first or second rotational direction around a rotational axis A. In some aspects, the actuator 110 may be coupled to and move a different component of the dispenser 100 relative to the shaft 120 without moving the shaft 120 itself.

The shaft 120 may comprise any suitable material that is susceptible to manufacturing, can withstand the stresses of the dispensing system, and does not adversely react with the components comprising the fluid material. In some aspects, the shaft 120 may include a metal, such as stainless steel. In other aspects, the shaft 120 may comprise carbide or similar materials.

Referring to FIGS. 6-9B, the shaft 120 may be substantially cylindrical and have a proximal end 122 and a distal end 124 opposite the proximal end 122. The proximal end 122 may fixedly attach to the actuator 110 such that when the actuator 110 moves, the shaft 120 also moves. It will be understood that, although depicted as cylindrical, the shaft 120 may include any other suitable shape, such as parallelepipeds or prisms.

The distal end 124 may be configured to contact a portion of the fluid material that will be dispensed and to control the quantity and method of dispensing. A groove 125 may be disposed on the shaft 120, for example at or near the distal end 124. While the groove 125 is depicted in the figures to be directly adjacent to the distal end 124, it will be understood that the groove 125 may be disposed elsewhere on the shaft 120, for example, close to, but not directly adjacent to, the distal end 124, close to or direction adjacent to the proximal end 122, or roughly centered between the distal end 124 and the proximal end 122.

The portion of the shaft 120 with the groove 125 has less structural material than the rest of the shaft 120. If viewed in a plane orthogonal to the linear distance from the proximal end 122 to the distal end 124, a cross-sectional area of the groove 125 is smaller than a cross-sectional area of the shaft 120 without the groove 125.

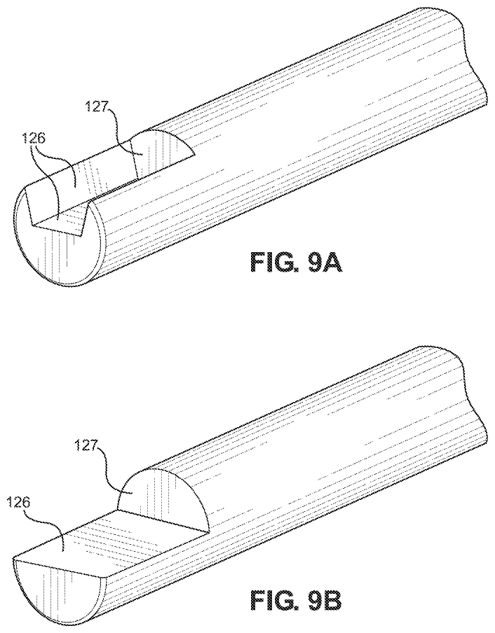

The groove 125 includes at least one wall 126 and a floor 127. Depending on the shape of the groove 125, additional walls 126 may be present. For example, if the groove 125 is substantially cuboidal or pyramidal in shape, as shown in FIG. 9A, the groove 125 may include three walls 126. Referring to the exemplary aspect of FIG. 9B, the groove 125 may include a single wall 126 as well. The dimensions of the walls 126 and the floor 127 may be varied based on the desired cutout shape and size and could depend on, for example, the desired use of the dispenser 100 or on the fluid material to be dispensed. In some aspects, the shaft 120 may include an angled planar surface (for example, at an angle between 0 and 90 degrees relative to the rotational axis A) that defines the groove 125, in which case the groove 125 may have a single wall 126 and no defined floor 127.

The groove 125 at least partially defines a passage 150 between the fluid chamber 106 and the outlet 108. The shaft 120 may be disposed in a plurality of positions, each position corresponding to a configuration of the passage 150, in which the passage 150 may be operatively opened or closed. When the passage 150 is at least partially open, the fluid material may flow from the fluid chamber 106 to the outlet 108, and when the passage 150 is closed, the fluid material is precluded from passing through the passage 150 to the outlet 108. The passage 150 is configured to have a variety of configurations, in which the passage 150 may be fully closed, fully open, or partially open and partially closed. When the passage 150 is in a fully opened configuration, the greatest quantity of fluid material may pass therethrough than when the passage 150 is in any other configuration.

When the actuator 110 rotates, it may rotate the shaft 120 along a rotational axis A. As the shaft 120 rotates, the groove 125 also rotates. The dispenser 100 may include a closed configuration, in which the fluid material is precluded from passing into the groove 125 and through the passage 150. The shaft 120 may be rotated into one or more open configurations, in which the fluid material is permitted to flow into the groove 125 and through the passage 150.

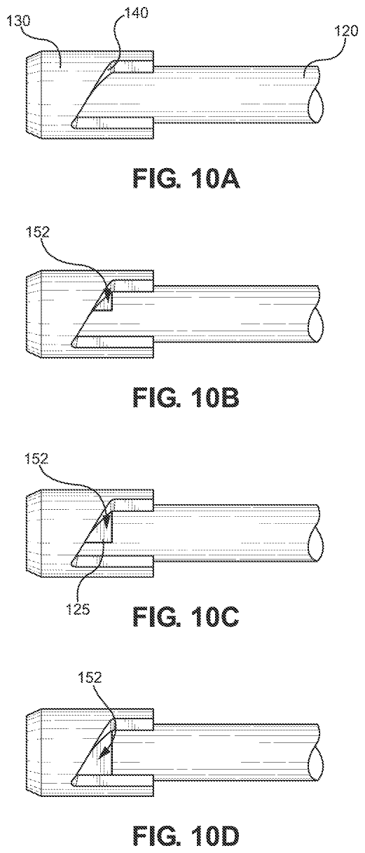

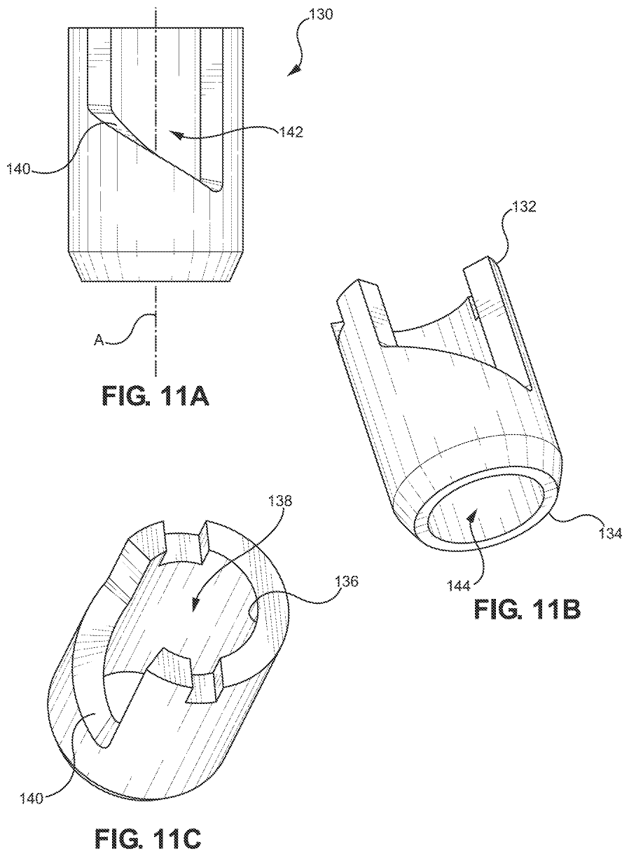

Referring to FIGS. 10A to 10D, a plurality of open configurations is depicted, where each open configuration defines a differently dimensioned entrance to the passage 150 depicted by a passage inlet 152. For example, the passage inlet 152 of FIG. 10B is smaller than the passage inlet 152 depicted in FIG. 10C and in FIG. 10D. The greater the passage inlet 152, the more fluid material may enter the passage 150 from within the fluid chamber 106. The dispenser 100 may cycle between any of the plurality of open configurations and the closed configuration to result in the desired dispensing pattern of the fluid material onto a substrate.

The dispenser may further include a bushing 130 configured to slidably engage with the shaft 120. Referring to FIGS. 11A to 11C, the bushing 130 has an inlet opening 142 at a proximal end 132 and an outlet opening 144 at a distal end 134. The bushing 130 has an interior surface 136 that defines a passage 138 extending through the bushing 130 between the inlet opening 142 and the outlet opening 144.

The inlet opening 142 may be dimensioned such that the shaft 120 may removably be inserted into the passage 138. In some aspects, it may be advantageous for the shaft 120 to freely rotate around the rotational axis A while the shaft 120 is at least partly within the passage 138. Alternatively, the bushing 130 may be configured to rotate around the shaft 120 and around rotational axis A.

When the shaft 120 is inserted into the bushing 130, the clearance between the interior surface 136 of the bushing 130 and the portion of the shaft 120 without the groove 125 should be large enough that the shaft 120 can freely move relative to the bushing 130, but small enough such that the fluid material to be dispensed cannot pass through the space between the shaft 120 and the interior surface 136.

In some aspects, the clearance between the interior surface 136 and the groove 125 on the shaft 120 should be large enough to define the passage 150, through which the fluid material may be permitted to flow.

The bushing 130 may include a cutout 140 that defines a portion of the inlet opening 142. The cutout 140 may comprise different shapes, and this disclosure is not limited to only the particular cutouts shown in the figures. In some aspects, the cutout 140 may include one or more of triangular, rectangular, or circular components.

The bushing 130 may be movable relative to the shaft 120, or the shaft 120 may be movable relative to the bushing 130. Depending on the relative position of the shaft 120 and the bushing 130, the cutout 140 may overlap the groove 125. When the cutout 140 overlaps the groove 125, fluid material within the fluid chamber 106 is permitted to enter the passage 150.

The relative position of the groove 125 to the cutout 140 may determine how much of the fluid material may enter the passage 150. Referring again to FIG. 10A, when there is no overlap, the fluid material is precluded from entering the passage 150. As the overlap increases, the amount of the fluid material that can enter the passage 150 at a given time also increases. The position of the inlet opening 142 of the bushing 130 relative to the groove 125 may define the passage inlet 152. FIG. 10D depicts the maximum overlap between the groove 125 and the cutout 140, which also shows the maximum overlap between the inlet opening 142 and the passage inlet 152. The maximum overlap permits the greatest amount of fluid to enter the passage 150.

The cutout 140 may be dimensions such that, when it moves relative to the groove 125, the passage inlet 152 increases or decreases in a linear manner. In some aspects, the bushing 130 and the shaft 120 may be dimensioned such that a linear correlation exists between the relative degree of rotation and the flow rate of the fluid material through the passage 150.

The aspects disclosed herein offer a number of advantages over existing technology. Devices currently used to dispense a fluid material onto a substrate utilized a piston-like needle that axially moves toward and away from an outlet orifice to open and close, respectively, and outlet for the fluid material to leave the dispenser. Such a setup requires a signal to be sent to the dispenser to force an actuator to move the needle. Additionally, those systems often rely on using air or another compressible gas to actuate movement of the needle. Because of this, the dispensing process takes up to several hundred milliseconds to complete.

It is often desirable to complete a dispensing action in less time. The present aspects detailed in this application can operate an actuator 110 to move the shaft 120 into the desired dispensing configuration in significantly less time than existing systems. For example, in some aspects, the shaft 120 may be moved in between about 100 milliseconds and about 200 milliseconds, in between about 50 milliseconds and about 100 milliseconds, in between about 10 milliseconds and about 50 milliseconds, and in between about 1 millisecond and about 10 milliseconds.

The decreased response time allows for faster adjustment of the dispensing process and permits for variation of dispensing parameters. For example, the dispensing process may include a reciprocal opening-and-closing that results in depositing of the fluid material onto a substrate. Such a process may result in various sizes, shapes, and dimensions of the dispensed material, for example, material formed in the shape of droplets, beads, or elongated strips.

The size and shape of the dispensed beads may be adjusted based by instructing the actuator 110 to move the shaft 120 from a closed configuration to an open configuration (resulting in the fluid material passing through the passage 150) and then, after a predetermined duration, moving the shaft 120 from the open configuration to the closed configuration (resulting in the blocking of fluid material from entering the passage 150). This cycle may be repeated to dispense a plurality of beads of the fluid material. It will be understood that the specific process for dispensing the fluid material may include additional or different steps, and that the specific open configuration of the dispenser 100 will depend on the desired size and shape of the dispensed fluid material.

Other suitable processes may be utilized as well to form various dispensed fluid shapes. For example, with reference again to FIGS. 10A to 10D, the actuator 110 may move the shaft 120 from one of the plurality of open configurations to another of the open configurations in which the passage 150 is obstructed more or less than in the previous open configuration. In such a scenario, the dispensed fluid will be formed in a first shape when the shaft 120 is in the first of the above open configurations and in a second shape when the shaft 120 is in the second of the above open configurations.

It will be understood that other steps may be involved in the dispensing process to result in different shapes and sizes of the dispensed fluid material. Repetitive opening and closing of the shaft 120 may result in, for example, a uniformly linear dispensing of the fluid material on the substrate, in formation of a plurality of uniform drops, or in a formation of drops that differ in size and shape.

The fluid material may be delivered to the fluid chamber 106 and to the outlet 108 through the passage 150 by a variety of suitable methods, for example, by pump or another displacement device, applied pressure by an air or gas, or by vacuum. In some aspects, the fluid material is constantly held under pressure to ensure constant flow. While this disclosure is not limited to a particular dispensing pressure, it will be understood that a suitable pressure would be high enough to move the fluid material at a desired flow rate through the passage 150 when the passage 150 is unobstructed, but low enough so as not to damage the seals or other components of the dispensing system 10.

In some aspects, the dispensing system 10 may include one or more sensors (not shown) to measure pressure throughout various portions of the dispensing system 10 and to relay commands based on the measurements to increase or decrease pressure of the fluid material.

The faster actuation time of the aspects disclosed throughout this application allows for dispensing a desired pattern on a substrate at a faster rate than with existing technology. Additionally, or alternatively, the dispensed pattern from a dispensing system of this application may include more variations per application area or per duration period of application. This allows more precise control of the application and alteration of the fluid material to the substrate.

Furthermore, the decreased actuation time decreases unnecessary interruptions in production. Existing systems, on the other hand, have greater delays due to the longer actuation time of moving a piston-like needle to open or close an outlet orifice. Some existing systems that have fixed-sized outlet orifices need to account for and change the material pressure accordingly to vary the output flow and/or the shape of the dispensed material. Furthermore, some existing systems need to change the velocity of the metering device. The faster operation reduces production delays and increases efficiency of system operators.

Additionally, the aspects disclosed herein allow for variation of the passage inlet 152, which, in turn, varies the final size and shape of the dispensed fluid material. Existing systems do not allow adjustments of the size and shape of the dispensing material during operation. Instead, the existing systems need to be paused or shut down to change the size of the outlet orifice or to replace one or more components of the system to result in a differently sized outlet orifice. The described aspects allow the dispenser 100 to retain constant pressure on the fluid material while simultaneously varying the size of the orifice. The outlet orifice size can be varied without long down-time, which increases manufacturing output and decreases operational man-hours.

While systems and methods have been described in connection with the various aspects of the various figures, it will be appreciated by those skilled in the art that changes could be made to the aspects without departing from the broad inventive concept thereof. It is understood, therefore, that this disclosure is not limited to the particular aspects disclosed, and it is intended to cover modifications within the spirit and scope of the present disclosure as defined by the claims.

What is claimed is:

1. A dispensing apparatus for dispensing a fluid, the dispensing apparatus comprising:
a dispenser body having a fluid chamber configured to receive the fluid;
an outlet disposed on the dispenser body and configured to fluidly communicate with the fluid chamber; and
a shaft disposed within the fluid chamber, the shaft at least partially defining a variable passage for the fluid to move therethrough from the fluid chamber to the outlet,
wherein the dispensing apparatus is configured to transition between a plurality of dispensing configurations, and the variable passage having a different dimension for each of the plurality of dispensing configurations.

2. The dispensing apparatus of claim 1, further comprising a nozzle disposed on the dispenser body, the nozzle being configured to receive the fluid from the outlet and to direct the fluid to a substrate.

3. The dispensing apparatus of claim 1, wherein the dispenser body further comprises an inlet in fluid communication with the fluid chamber, the inlet configured to receive the fluid from a fluid source.

4. The dispensing apparatus of claim 1, further comprising an actuator configured to transition the dispensing apparatus between the plurality of dispensing configurations.

5. The dispensing apparatus of claim 4, wherein the actuator includes a servo motor, a stepper motor, or a direct current motor.

6. The dispensing apparatus of claim 4, wherein the shaft is configured to be rotated in a first direction about a rotational axis and in a second direction opposite the first direction.

7. The dispensing apparatus of claim 4, further comprising a bushing having an interior surface defining a bushing passage, the shaft being slidably insertable into the bushing passage such that the shaft contacts the interior surface of the bushing.

8. The dispensing apparatus of claim 7, wherein the bushing is movable by the actuator, and wherein each of the plurality of dispensing configurations corresponds to a movement of the bushing.

9. The dispensing apparatus of claim 7, wherein the bushing further comprises a cutout, the cutout defining a bushing inlet opening.

10. The dispensing apparatus of claim 9, wherein the shaft includes a longitudinal body extending along a rotational axis, a distal end, and a proximal end opposite the distal end, the shaft having a groove at the distal end.

11. The dispensing apparatus of claim 10, wherein the variable passage has its greatest dimension when the dispensing apparatus is in one of the plurality of dispensing configurations in which the groove of the shaft overlaps with the cutout of the bushing, and wherein the variable passage has its smallest dimension when the dispensing apparatus is in another of the plurality of dispensing configurations in which the groove of the shaft does not overlap with the cutout of the bushing.

12. The dispensing apparatus of claim 11, wherein the fluid is precluded from moving through the variable passage when the variable passage has its smallest dimension.

13. The dispensing apparatus of claim 1, wherein the dispensing apparatus is configured to transition between the plurality of dispensing configurations in less than about 100 milliseconds.

14. The dispensing apparatus of claim 13, wherein the dispensing apparatus is configured to transition between the plurality of dispensing configurations in less than about 10 milliseconds.

15. A system for dispensing a fluid onto a substrate, the system comprising:
a dispensing apparatus having a dispenser body defining a fluid chamber, the fluid chamber being configured to receive the fluid;
an inlet in fluid communication with the fluid chamber and configured to receive the fluid from a fluid source;
an outlet in fluid communication with the fluid chamber and for the fluid to pass therethrough out of the fluid chamber;
a metering member disposed within the fluid chamber, the metering member defining a variable passage for the fluid to move therethrough from the fluid chamber to the outlet;
a nozzle disposed on the dispensing apparatus and configured to direct the fluid from the outlet to the substrate; and
an actuator configured to transition the dispensing apparatus between a plurality of dispensing configurations,
wherein the variable passage has a different dimension at each of the plurality of dispensing configurations.

16. The system of claim 15, wherein the fluid is dispensed in the form of a bead.

17. The system of claim 16, wherein the substrate is configured to be moved relative to the system at a predetermined speed, and wherein the bead is configured to have a plurality of dimensions, each of the plurality of dimensions of the bead corresponding to the predetermined speed at which the substrate is moved relative to the system.

18. The system of claim 15, further comprising a bushing having an interior surface defining a bushing passage and a cutout defining a bushing inlet opening,
wherein the metering member is slidably insertable into the bushing passage such that the metering member contacts the interior surface of the bushing.

19. The system of claim 18, wherein the metering member is movable by the actuator relative to the bushing, such that each of the plurality of dispensing configurations corresponds to a movement of the metering member.

20. The system of claim 18, wherein the bushing is movable by the actuator, such that each of the plurality of dispensing configurations corresponds to a movement of the bushing.

21. The system of claim 15, wherein the metering member includes a longitudinal body extending along a rotational axis, a distal end, and a proximal end opposite the distal end, the longitudinal body having a groove at the distal end.

22. The system of claim 15, wherein the variable passage is configured to have a first opening when the dispensing apparatus is in a first configuration and a second opening when the dispensing apparatus is in a second configuration, the first opening being larger than the second opening.

23. A method of dispensing a fluid onto a substrate using a dispensing apparatus with a dispenser body defining a fluid chamber, the method comprising:
operating the dispensing apparatus in a first configuration to dispense a first quantity of the fluid from an outlet of the dispensing apparatus;
rotating a shaft disposed within the fluid chamber, the shaft at least partially defining a variable passage for the fluid to move therethrough from the fluid chamber to the outlet; and
operating the dispensing apparatus in a second configuration to dispense a second quantity of the fluid from the outlet of the dispensing apparatus, the first quantity being different from the second quantity.

24. The method of claim 23, wherein the shaft has a groove at a distal end thereof.

25. The method of claim 24, further comprising aligning the groove on the shaft with a cutout on a bushing disposed adjacent to the groove.

26. The method of claim 25, wherein the first configuration corresponds to a first alignment of the groove relative to the cutout and the second configuration corresponds to a second alignment of the groove relative to the cutout, the first alignment being different from the second alignment.

27. The method of claim 23, further comprising rotating the shaft to transition the dispensing apparatus from the second configuration to a third configuration to dispense a third quantity of the fluid from the outlet of the dispensing apparatus, the third quantity being different from the first quantity and the second quantity.

28. The method of claim 23, wherein the first quantity is substantially zero.
